(19) United States
(12) Patent Application Publication
(10) Pub. No.: US 2006/0133993 A1
(43) Pub. Date: Jun. 22, 2006

(54) Hydrocarbon fuel process using fuels with high autoignition temperature

(75) Inventors: Gunther H. Dieckmann, Walnut Creek, CA (US); Dennis J. O'Rear, Petaluma, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 11/016,326

(22) Filed: Dec. 16, 2004

(51) Int. Cl. C01B 3/26

(52) U.S. Cl. 423/651; 423/653

(57) ABSTRACT

A process for autothermal reforming of a hydrocarbon fuel to produce hydrogen for use in a fuel cell. The process requires the hydrocarbon fuel passed over a Group VIII metal catalyst on a solid support have an autoignition temperature greater than 600 degrees F., be low in sulfur content, have an aromatics+naphthenes content of less than 70 volume %, and preferably a oxygen content of below 1.8 wt %.

### BACKGROUND OF THE INVENTION

Fuel cells are becoming increasingly important for the generation of electrical energy for various uses. Hydrogen is one of the important fuels used in many fuel cells such as PEM (proton exchange membrane) fuel cells, solid oxide fuel cells, molten carbonate fuel cells and other fuel cells. Hydrogen generation and hydrogen containment as well as performance stability and longevity are still significant challenges in the development of fuel cell systems. A particular use of fuel cells is in vehicles that are being developed as an alternative to internal combustion engine powered vehicles. While demonstration PEM fuel cell vehicles have been built that use compressed hydrogen, or liquid hydrogen, it may be more practical to generate hydrogen for the fuel cell vehicle by reforming methanol or more readily available fuels, such as jet, diesel, gasoline, or other hydrocarbons available from chemical or petroleum processing plants in an on-board reformer; thereby, avoiding the need to compress and store the hydrogen in expensive high pressure carbon fiber tanks or cryogenic Dewars. An on-board vehicle reformer also avoids the need to centrally generate and store large quantities of hydrogen. In a hydrocarbon reformer, the hydrocarbon fuel is blended with steam and/or air before being passed over a reformer catalyst to produce hydrogen and carbon monoxide. The reformer catalyst can consist of Ni, Pt, and/or other platinum group metals supported on for example alumina, zirconia, ceria, cordierite, or zirconia coated cordierite, and is often additionally promoted with alkaline earth or rare earth oxides. Additional hydrogen can be generated by passing the product gases from the reformer catalyst bed over a water gas shift catalyst bed. This subsequent hydrogen rich stream may also pass over a selective oxidation catalyst to reduce the residual carbon monoxide to an acceptable level. CO₂ produced in the reformer can be left in the hydrogen rich stream where it acts as a diluent or may be removed by various methods. The purified hydrogen rich stream is then fed to a fuel cell such as a PEM (proton exchange membrane) fuel cell stack or other fuel cell stack, where the hydrogen combines with oxygen, typically from air, to produce electric power for a motor. Optionally tail gas from the fuel cell may be combusted to provide heat to the system. An example of an integrated fuel processor, fuel cell stack, and tail gas oxidizer with CO₂ removal is described in U.S. Pat. No. 6,682,838 which is incorporated herein by reference in its entirety

One of the major problems with generating hydrogen for a fuel cell vehicle in an on-board reformer is that the reformer must consume a minimum amount of fuel upon start-up and be able to handle large dynamic load swings in seconds. The reformer catalyst typically operates at a temperature above 500 C and more preferably above 600 C and even more preferably above 700 C, thus it is critical to minimize both the weight and volume of the reformer catalyst. Consequently, highly desirable fuels for fuel cell vehicles are those hydrocarbon fuels that are easily reformed, thus minimizing the amount and volume of reformer catalyst.

The patent literature provides some guidance toward this goal. World Patent Application, WO98/08771 (PCT/US 97/14906) assigned to A. D. Little teaches that fuel cell fuels can include distillate fuels, gasoline, and alcohols. World Patent, WO 00/39873 (PCT/US 99/30264) assigned to International Fuel Cells, LLC teaches that since gasoline is the most generally available fuel for vehicle use that gasoline is also the most desirable fuel for a fuel cell powered vehicle provided that the sulfur compounds in the gasoline are reacted over a nickel containing adsorbent prior to reforming. The ‘WO 00/39873’ application recognizes that when there are very few fuel cell vehicles on the road, a likely fuel will be gasoline given its availability. However as the number of fuel cell vehicles on the road increase, it may become economically feasible to generate, distribute and market a more desirable fuel cell fuel other than gasoline. ‘WO 00/39873’ does not teach what this more desirable fuel could be.

World Patent, WO200144412 assigned to Idemitsu Kosan Co, teaches that a desulfurized light naphtha for a fuel cell reformer should have a weight ratio of iso-paraffins to normal paraffins of at least one. JP2001279271 also assigned to Idemitsu Kosan teaches that 90 volume percent of the fuel should have a boiling range between 140 to 270 C ( 284 to 518 F), have a molar ratio of carbon to hydrogen in the mixture of 0.5 or less, and be free of aromatic compounds. In other words, a fuel cell fuel should preferably contain paraffins, which have a carbon to hydrogen ratio of less than 0.5.

Mono-olefins, such as 1-octene for example, and naphthlenes such as methyl cyclohexane have a carbon to hydrogen ratio of exactly 0.5, and thus would also be permitted. World Patent, WO0182401 assigned to Idemitsu Kosan CO teaches that a fuel with a density of 0.60 to 0.72 g/cm³ at 15 C, a surface tension at 20 C of 170 to 250 mN/cm and an octane value of 70 or more can be used in both an internal combustion engine as well as a fuel cell vehicle. Though not directly obvious, limiting the density of the fuel to be between 0.60 and 0.72 g/cm³ excludes conventional gasoline, where the density is normally between 0.72 and 0.78 g/cm² due to the presence of higher density aromatic and naphthenic compounds. Thus WO0182401 teaches that the preferred fuel is rich in paraffins and possibly olefins. However one of the peculiar aspects of WO0182401 is that it teaches that the octane rating of the fuel should be greater than 70 and more preferably greater than 80 in order for the fuel to be used in both internal combustion engines as well as fuel cell vehicles. This octane requirement according to “401” is to prevent knocking in internal combustion engines. However modern high compression internal combustion engines require hydrocarbon fuels with an octane rating of 87 to 93. WO0182401 never teaches that octane is an important parameter in selecting a fuel for a fuel cell vehicle.

It would be advantageous to have a process for reforming hydrocarbons to hydrogen and a fuel specifically designed for the process that can achieve nearly complete conversion of the fuel and avoids undesirable byproduct formation. The present invention provides such a process and fuel.

### SUMMARY OF THE INVENTION

The present invention provides a process for autothermal reforming of a hydrocarbon fuel to produce hydrogen for use in a fuel cell, comprising:

passing a hydrocarbon fuel having an autoignition temperature of above 600 degrees F., a total sulfur content of less than 30 ppm by weight, and an aromatics+naphthenes content of less than 70 volume % over a catalyst comprising a Group VIII metal on a solid support, at reforming conditions, to produce an effluent comprising hydrogen; and using at least a portion of the effluent comprising hydrogen in a fuel cell to produce electricity.

Among other factors we have found that the composition of the fuel used in an autothermal reformer to make hydrogen for use in a fuel cell must have particular properties in order to be readily reformed and avoid undesirable byproduct formation. In particular the fuel used in the process of the present invention must have an autoignition temperature above about 600 degrees F., must be low in sulfur, and should have a aromatics+naphthenes content below about 70 volume %. Surprisingly, we have found that the autoignition temperature of the fuel is a critical feature in the performance of the fuel. Fuels having a low autoignition temperature (below about 600 degrees F.) performed poorly in the process of the present invention. The low autoignition temperature fuels tended to have unacceptably high conversion to light hydrocarbons such as methane, ethane, etc. and resulted in decreased H₂ yield and rapid fouling of the preferred catalyst in the process of the present invention. Oxygenated species also tended to have a negative effect on the performance of the fuel in the autothermal reformer. Thus we have determined that the total oxygen content of the fuel should most preferably be kept to below about 1.5 weight percent.

### DETAILED DESCRIPTION OF THE INVENTION

The present invention provides a novel process for the autothermal reforming of liquid hydrocarbons to form hydrogen for use in a fuel cell to make electricity. Preferably the liquid hydrocarbons comprise components that are liquid at ambient temperature and pressure. The hydrocarbon fuel used in the present invention may also contain some components that are quite volatile such as butanes and even lighter materials. The process comprises passing a hydrocarbon fuel having an autoignition temperature of at least 600 degrees F., a total sulfur content of less than 30 ppm by weight, and a aromatics+naphthenes content of less than 70 volume % over a catalyst comprising a Group VIII metal on a solid support, at reforming conditions, to produce an effluent comprising hydrogen.

We have discovered that low sulfur oxygenate free hydrocarbons are most easily reformed in an autothermal reformer when the autoignition temperature of the fuel is above about 600 degrees F., more preferably above about 625 degrees F., even more preferably above about 650 degrees F., still more preferably above about 670 degrees F. This is actually quite surprising due to the lack of teaching in the fuel processor art of any relationship of autoignition temperature of the fuel to the fuel's performance in a reformer. The autoignition temperature as defined in ASTM E659 is the lowest temperature at which a fuel will produce hot-flame ignition in air at atmospheric pressure without the aid of an external energy source such as a spark or a flame.

Furthermore we have found that variations in the concentration of paraffins, olefins, aromatics and naphthenic compounds in a fuel processor fuel run under specific autothermal conditions have very little impact on the reformability of the fuel provided that the aromatic content or naphthenic content of the fuel is less than about 70 volume % and more preferably less than 60 vol %, and that the fuel contains low levels of, or is free of, oxygen containing compounds. We have surprisingly found that the addition of ethanol to gasoline reduces the ability of gasoline to be easily reformed in a fuel processor under the conditions of the present invention.

Low sulfur hydrocarbon fuels are those fuels with a boiling range from about 0 to about 600 F and more preferably from about 32 to 430 F with a sulfur content of less than about 30 ppm sulfur, preferably less than 10 ppm S, and even more preferably less than 5 ppm S. Sources of low sulfur hydrocarbon fuels include but are not limited to, butanes, pentanes, hexanes, FCC gasoline, hydrotreated FCC gasoline, gasoline, hydrotreated gasoline, straight run naphtha, hydrotreated straight run naphtha, reformate, alkylate, hydrobate, hydrocracked naphtha, jet, hydrotreated jet, ethylene steam cracker gasoline, hydrotreated ethylene steam cracker gasoline, hydrocarbons from a Fischer-Tropsch gas to liquids plant, hydrotreated gas condensates and/or combinations thereof. High sulfur fuels containing sulfur may rapidly poison reformer catalysts. High sulfur feeds can be used in a sulfur sensitive fuel cell reformer (fuel processor), if the feed is first passed over a sulfur removal system, such systems include but are not limited to mild hydroprocessing as taught for example in U.S. Pat. No. 6,475,376 or nickel adsorbents such as taught in World Patent, WO 00/39873 (PCT/US99/30264). U.S. Pat. No. 6,475,376 is incorporated by reference herein in its entirety. Some fuel processor catalysts may be more tolerant of sulfur contamination or sulfur in the fuel. For example certain nickel based reforming catalysts may be more sulfur tolerant than Pt catalysts. However since the hydrogen produced in the process of the present invention is used as a fuel for a fuel cell it is still desirable to reform as low a sulfur content fuel as possible. Most fuel cells, including PEM fuel cells are poisoned (deactivated) by even relatively low levels of sulfur.

The hydrocarbons produced by a Fischer-Tropsch (FT) gas to liquids process are particularly well suited as a component for the fuel for autothermal reforming process of the present invention at least in part because they are typically very low in sulfur which is also a requirement for the fuel used in the present invention. However FT hydrocarbon cuts tend to have low autoignition temperatures since they are comprised predominantly of highly linear hydrocarbon chains. FT hydrocarbons may also need to be treated to remove at least a portion of the oxygenates that are often present in many FT liquids. Thus most FT hydrocarbon cuts would require addition of a high autoignition temperature component (such as toluene) to be suitable for use as a fuel in the autothermal reforming process of the present invention. Addition of such components would help increase the autoignition temperature of the fuel to above 600 degrees F.

FT hydrocarbon cuts can be upgraded to make fuel components having higher autoignition temperatures by various means. One such means includes catalytic reforming of FT material (such as naphtha) to make a product having increased aromatic content. A process that discloses naphtha reforming of a FT effluent is U.S. Pat. No. 6,693,138 which is herein incorporated by reference in its entirety.

Quite a variety of oxygenates may be present in FT liquids including aldehydes, ketones, ethers, and esters as well as alcohols. Levels of oxygenate containing compounds greater than about 1 wt % as total oxygen can start to decrease the performance of a hydrocarbon fuel in the process of the present invention.

As mentioned above oxygenated species also tended to have a negative effect on the performance of the fuel in the autothermal reformer. Thus we have determined that oxygenated species in the fuel should be kept fairly low to avoid excessive undesirable methane, ethane, and light hydrocarbon yield. When determined as the wt % total oxygen, the fuel should contain less than 1.8%, preferably less than 1.5%, more preferably less than 1.2%, and most preferably less than 1.0 % total covalently bonded oxygen. (The determination of total oxygen content of the fuel should be made after purging with an inert gas such as nitrogen or argon to remove any dissolved oxygen.) Oxygen containing compounds or oxygenates include but are not limited to alcohols, ethers, esters, ketones, aldehydes, peroxides, carboxylic acids, etc. Examples of specific oxygenates include but are not limited to; methanol, ethanol, iso-propanol, methyl tert-butyl ether, ethyl tert-butyl ether, tert-amyl methyl ether, ethyl acetate, acetone, acetaldehyde, acetic acid etc.

Autothermal reforming is a process where a hydrocarbon stream is mixed with an oxygen containing stream and steam prior to contacting a reforming catalyst. In autothermal reforming, the oxygen (as atomic O) to carbon ratio is in the range of 0.5 to 1.0 and more preferably in the range of 0.7 to 0.9 with a steam to carbon ratio of 0.2 to 3.0 and more preferably 0.8 to 2.2 in the final mixed hydrocarbon/steam/oxygen containing stream. It is important in autothermal reforming of hydrocarbons to avoid pre-ignition or pre-burning of the hydrocarbon fuel prior to contact with the reformer catalyst. This is accomplished by either by injecting the hydrocarbon fuel into a heated steam/air stream into a region just in front or above the reformer catalyst. Or by injecting air into the steam/hydrocarbon stream into the region just in front or above the reformer catalyst. Pre-ignition or pre-burning is normally not a problem in a vehicle reformer due to the engineering necessity of minimizing the weight and volume of the hydrocarbon reformer in order to minimize fuel consumption upon startup as well as improve the response time to dynamic load changes.

Not wishing to be limited by theory, we believe that the more the fuel is pre-burned or pre-oxidized prior to contacting the reformer catalyst, the harder it is to reform. Thus high octane fuels, which are not as easily oxidized also turn out to be the easiest fuels to reform. Thus the addition of oxygenated species such as ethanol suppresses the reformability of a hydrocarbon fuel.

In contrast to the prior art which found that paraffins are the most preferred fuel cell fuels, we have found that any combination of paraffins, olefins, naphthenes, and aromatic compounds are acceptable provided that the aromatic or naphthenic content does not exceed about 70 volume percent and more preferably 60 volume percent of the fuel.

Not to be limited by theory, we believe that the flexibility in fuel composition is the result of the high temperature flame front created by the partial combustion of gasoline or other hydrocarbons in the front part of the reformer catalyst bed. Temperatures in the flame front can easily exceed 800 C. Thus these high temperatures allow aromatic and naphthenic compounds to be reformed. In order to achieve these high flame front temperatures, the oxygen to carbon ratio should be greater than 0.5 and more preferably greater than 0.7.

Gasoline is usually a blend of different refinery process streams. Likewise the ideal fuel cell fuel can be a blend of different refinery and other hydrocarbon processing streams provided that the autoignition temperature is above about 600 degrees F., more preferably above about 625 F, even more preferably above about 650 F, and still more preferably above about 670 F. Since sulfur is a poison to the fuel cell stack as well as the reformer catalyst, it is highly desirable to create fuel cell fuels from low sulfur streams. Refinery streams that can be blended together to create ideal fuel cell fuels include but are not limited to, butanes, pentanes, hexanes, FCC gasoline, hydrotreated FCC gasoline, straight run naphtha, hydrotreated straight run naphtha, reformate, alkylate, hydrocracked naphtha, hydrotreated light distillate, hydrotreated mid-distillates, jet and hydrotreated jet. Other hydrocarbon sources that can also be blended together or used straight in fuel cell reformers for vehicles include, hydrotreated natural gas condensates, ethylene steam cracker gasoline, and hydrotreated ethylene steam cracker gasoline. Thus easy to reform hydrocarbon fuels can be prepared by blending together low autoignition temperature fuel component streams such as hydrotreated straight run naphtha and hydrotreated natural gas condensates with high autoignition temperature fuel component streams such as reformate, alkylate, or even hydrotreated FCC gasoline.

The autoignition temperature of a fuel can be determined by ASTM method E659. However this method uses a large 500 ml glass flask to avoid possible catalytic effects of metals. However since commercial autothermal reformers will be built from stainless steel or other heat resistant alloys. The autoignition temperature of the fuels used in this patent was measured in a 1 inch diameter stainless steel (304) by 3 inch long stainless steel vessel. In this way possible catalytic surface effects due to metal alloys were taken into consideration.

### EXAMPLES

### Example 1

### Reforming Performance of Fuels

To determine the reforming performance of several hydrocarbon fuels, a small scale test apparatus was built in which the test fuel was sprayed through an 8 micron orifice into a 500 C steam swept chamber at a steam to carbon mole ratio of 2.0. This fuel/steam mixture was then blended with air at an oxygen (as O) to carbon ratio of 0.8 approximately 18 cm above the catalyst bed. The fuel/steam/air stream then passed through 0.25 grams of a Ni-based reformer catalyst held at 750 C in a furnace. After condensing the excess water from the product gases, the concentration of hydrogen, carbon monoxide, carbon dioxide, nitrogen, methane, and any additional hydrocarbons was measured using a Wasson gas chromatograph.

### Example 2

### Reforming Performance of Several Fuels

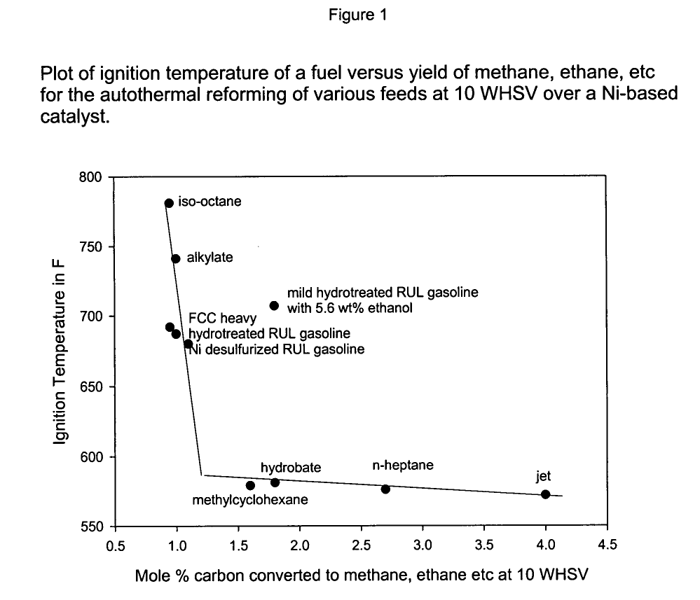

This example shows the reforming performance of several fuels having different compositions using the protocol of example 1. FIG. 1 shows the Ignition Temperature of the selected fuels versus the Mole % carbon converted to methane, ethane, and other light hydrocarbons at 10 weight hourly space velocity. A low yield of the methane, ethane and light hydrocarbons indicates that the feed was easily reformed. A high yield (above about 1.5 mole %) of methane, ethane and light hydrocarbons indicates that the fuel will perform poorly in the process of the present invention due to unacceptable levels of byproducts.

As can be easily seen from FIG. 1, the reforming performance of the fuel in the reforming process of the present invention is dependent upon the ignition temperature of the fuel. The exception to this finding was fuels containing high levels of oxygenates such as ethanol containing fuels.

What is claimed is:

1. A process for autothermal reforming of a hydrocarbon fuel to produce hydrogen for use in a fuel cell, comprising:
passing a hydrocarbon fuel having an autoignition temperature of above 600 degrees F., a total sulfur content of less than 30 ppm by weight, an aromatics+naphthenes content of less than 70 volume %, and containing less than 1.8 wt % total oxygen, over a catalyst comprising a Group VII metal on a solid support, at reforming conditions, to produce an effluent comprising hydrogen; and
passing at least a portion of the effluent comprising hydrogen to a fuel cell to produce electricity.

2. The process of claim 1 wherein the hydrocarbon fuel further comprises less than 1.5 wt % percent of total oxygen.

3. The process of claim 1 wherein the Group VII metal is selected from the group consisting of Pt, Pd, and Ni.

4. The process of claim 1 wherein the autothermal reforming is carried out onboard a fuel cell powered vehicle.

5. The process of claim 1 wherein the hydrocarbon fuel has an ignition temperature above about 625 degrees F.

6. The process of claim 3 wherein the Group VII metal is Ni.

7. The process of claim 1 wherein the hydrocarbon feed has a total sulfur content of less than 5 ppm by weight.

8. The process of claim 1 wherein the hydrocarbon fuel has an ignition temperature above about 650 degrees F.

9. The process of claim 1 wherein the hydrocarbon fuel further comprises less than 1.2 wt % percent of total oxygen.

10. The process of claim 1 wherein the hydrocarbon fuel further comprises less than 1.0 wt % percent of total oxygen.

11. The process of claim 1 wherein at least a portion of the hydrocarbon fuel is produced by a Fischer-Tropsch gas to liquids process.
